(19) United States
(12) Patent Application Publication
(10) Pub. No.: US 2014/0000136 A1
(43) Pub. Date: Jan. 2, 2014

(54) FRONT PANEL ASSEMBLY WITH IDENTOFICATION PLATE

(71) Applicants: HUNG-YI WU, Tu-Cheng (TW); LI-REN FU, Shenzhen City (CN)

(72) Inventors: HUNG-YI WU, Tu-Cheng (TW); LI-REN FU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., ShenZhen City (CN)

(21) Appl. No.: 13/553,839

(22) Filed: Jul. 20, 2012

(30) Foreign Application Priority Data
Jun. 29, 2012 (CN) 2012102211440

(51) Int. Cl. G09F 15/00

(52) U.S. Cl. 40/606.15

(57) ABSTRACT

A front panel assembly includes a front panel body and an identification plate. The identification plate includes a main body marked with a logo and rotatably attached to the panel body, and a weight piece attached to the main body at a bottom of the logo. The main body of the identification plate is made of plastic. The weight piece is made of steel. If the panel body is rotated, gravity acts on the weight piece driving the main body to rotate until the weight piece is toward the ground, thereby making the logo always appear to be upright.

### BACKGROUND

1. Technical Field

The present disclosure relates to front panels for electronic products, and particularly to a front panel with an identification plate.

2. Description of Related Art

Referring to FIG. 5, a front panel 100 of the computer may be marked with an identification plate 102, which includes a logo 103 in a fixed orientation. However, because of the fixed orientation, if the computer is rotated, such as being laid on its side to better fit on a desk, the logo may become unrecognizable or unattractive, which is not desirable for brand management.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, exploded view of an exemplary embodiment of a front panel assembly, which includes a front panel and an identification plate.

FIG. 2 is an enlarged view of the identification plate of FIG. 2, but viewed from another perspective.

FIGS. 3 and 4 are assembled, isometric views of the front panel assembly of FIG. 1, but shows two different usage states.

FIG. 5 is a schematic view of a front panel of a related art.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

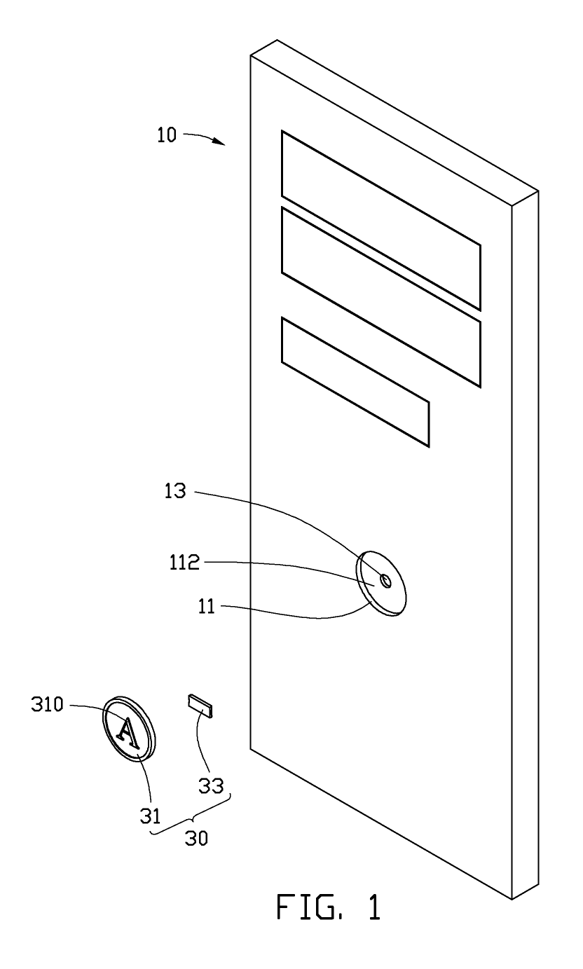

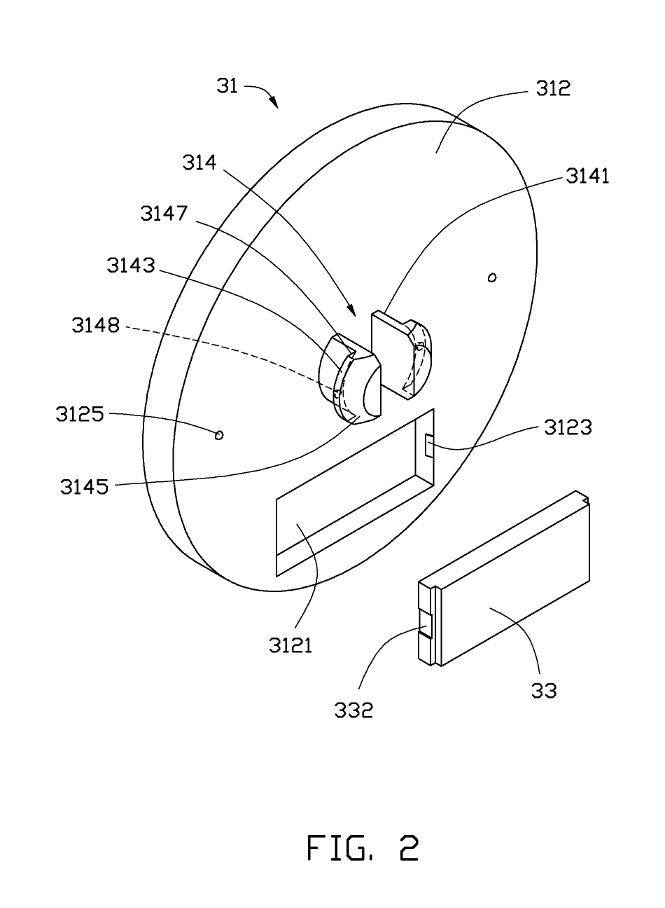

Referring to FIGS. 1 and 2, an exemplary embodiment of a front panel assembly for an electronic product, such as a computer, includes a front panel 10 and an identification plate 30.

The front panel 10 defines a round recess 11 in a front side, and a round through hole 13 in a bottom wall 112 of the recess 11.

The identification plate 30 includes a main body 31 and a weight piece 33.

In one embodiment, the main body 31 includes a round logo plate 312, and a mounting portion 314 extending from a center of a back side of the logo plate 312. A logo 310 is attached on a front side of the logo plate 312. A rectangular receiving area 3121 is recessed in the back side of the logo plate 312, below the logo 310. Two resilient locking tabs 3123 respectively extend from opposite sides bounding the receiving area 3121. Two bulges 3125 protrude from the back side of the logo plate 312, arranged at opposite sides of the mounting portion 314. The mounting portion 314 includes two spaced resilient semi-cylindrical pins 3141. Each of the pins 3141 includes a retaining tab 3143 extending from a distal end of the pin 3141 away from the other pin 3141. Each of the retaining tabs 3143 forms a stop surface 3147 facing the logo plate 312, and a tapered guide slope 3145 opposite to the logo plate 312. A bulge 3148 protrudes from the stop surface 3147 of each of the pins 3141.

The weight piece 33 is a rectangular board and defines two cutouts 332 in its opposite end surfaces.

The identification plate 30 is made of a low-density material. The weight piece 33 is made of a high-density material. In one embodiment, the identification plate 30 is made of plastic, and the weight piece 33 is made of steel.

In assembly, the weight piece 33 is received in the receiving area 3121 of the identification plate 30. The locking tabs 3123 of the identification plate 30 are correspondingly engaged in the cutouts 332 of the weight piece 33, to fix the weight piece 33 to the identification plate 30. The identification plate 30 is attached to the front panel 10 with the logo plate 312 received in the recess 11 and the pins 3141 being deformed toward each other to extend through the through hole 13. The guide slopes 3145 make the pins 3141 easily extend through the through hole 13. The pins 3141 are restored after passing through the through hole 13. Thus, the stop surfaces 3147 of the retaining tabs 3143 are blocked by a back side of the front panel 10 to prevent the identification plate 30 from inadvertently disengaging from the front panel 10. Because of the bulges 3148 and 3125, great friction due to direct contact between the front panel 10 and the identification plate 30 is avoided.

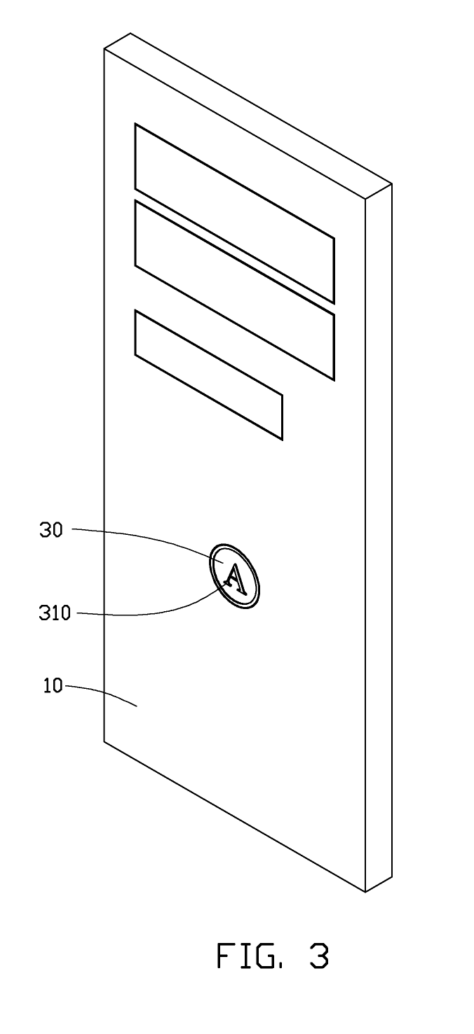

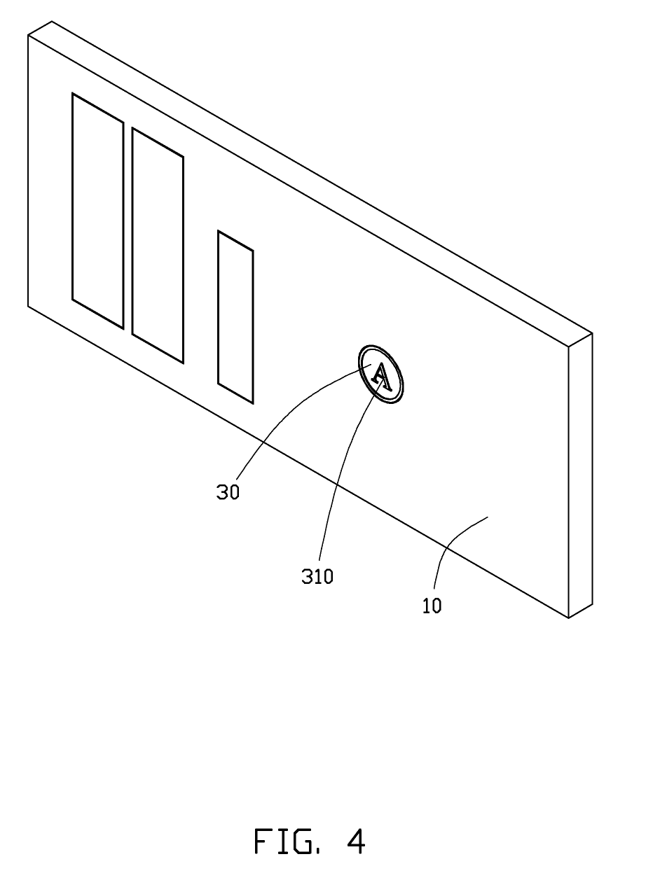

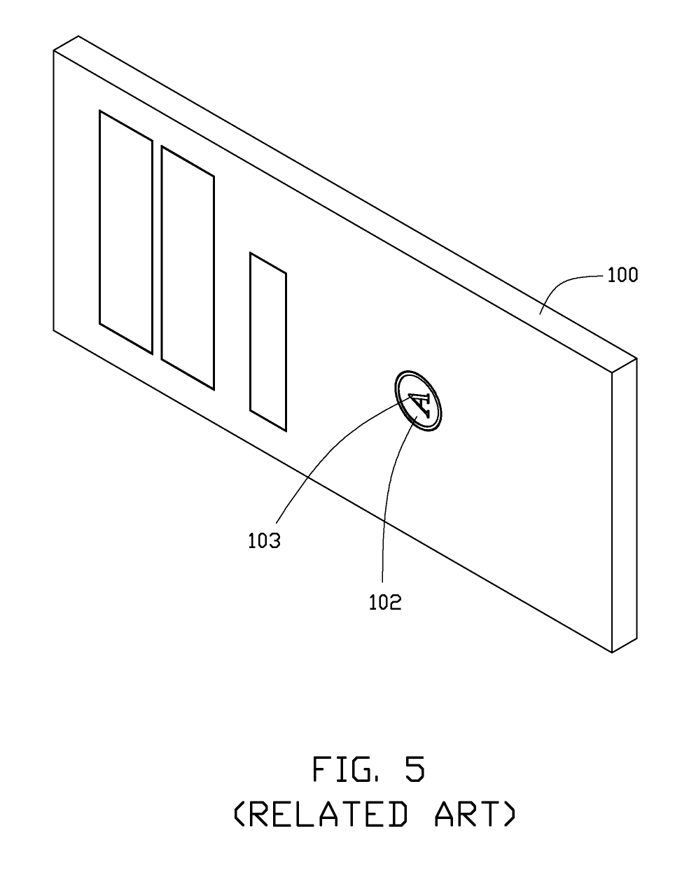

Referring to FIGS. 3 and 4, in use, if the front panel 10 rotates, gravity acts on the weight piece 33 driving the identification plate 30 to rotate until the weight piece 33 is towards the ground, thereby making the logo 310 to be always upright on the front panel 10 even when the orientation of the front panel 10 is changed.

It is to be understood, however, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A front panel assembly, comprising:
a front panel; and
an identification plate comprising:
a main body marked with a logo, and rotatably attached to the front panel; and
a weight piece fixed to the main body, at a bottom of the logo along an upright orientation of the logo;
wherein the weigh piece is made of material which has a higher density than the main body.

2. The front panel assembly of claim 1, wherein the front panel defines a through hole, the main body of the identification plate comprises a logo plate, and a mounting portion extending from a back side of the logo plate and rotatably engage in the through hole of the front panel, the logo is marked on a front side of the logo plate.

3. The front panel assembly of claim 2, wherein the mounting portion comprises two resilient pins split from each other, each of the pins comprises a retaining tab extending from a distal end of the pin away from the other pin, each of the retaining tabs forms a stop surface facing the logo plate, and a tapered guide slope opposite to the logo plate.

4. The front panel assembly of claim 3, wherein a bulge protrudes from the stop surface of each of the pins, two bulges protrude from the back side of the logo plate, respectively arranged at opposite sides of the mounting portion, the bulges of the pins and the bulges of the logo plates respectively face the back side and the front side of the front panel.

5. The front panel assembly of claim 4, wherein the front panel defines a recess in the front side, the logo plate is received in the recess, the though hole is defined in a bottom wall of the recess.

6. The front panel assembly of claim 1, wherein the logo plate defines a receiving area in a back side of the logo plate, below the logo along the upright orientation of the logo, the weight piece is received in the receiving area.

7. The front panel assembly of claim 6, wherein the weight piece defines two cutouts in opposite end surfaces of the weight piece, two resilient locking tabs respectively extend from opposite sides bounding the receiving area, the locking tabs are engaged in the corresponding cutouts.

8. The front panel assembly of claim 1, wherein the identification plate is made of plastic, and the weight piece is made of steel.
